(19) United States
(12) Patent Application Publication
(10) Pub. No.: US 2011/0301049 A1
(43) Pub. Date: Dec. 8, 2011

(54) Fluid Flow Contour Control Using Flow Resistance

(75) Inventors: Joel P. Golden, Fort Washington, MD (US); Peter B. Howell, JR., Gaithersburg, MD (US)

(73) Assignee: The Government of the United States of America, as represented by the Secretary of the navy

(21) Appl. No.: 12/794,275

(22) Filed: Jun. 4, 2010

(51) Int. Cl. C40B 30/04; C40B 40/08

(52) U.S. Cl. 506/9; 506/17

(57) ABSTRACT

A micro-fluidic device and a method of use are disclosed. The device includes a micro-channel with an inlet port at a first end and an outlet port at a second end. A first fluid, such as air or liquid or both, is disposed in the micro-channel. A focusing structure extends into the micro-channel, whereby when a pulse of a second fluid is introduced to the channel, the pulse advances adjacent sides of the micro-channel at a faster rate than would occur without the focusing structure.

### BACKGROUND

The exemplary embodiment relates to fluidic devices. It finds particular application in connection with a device and method for controlling fluid pulse shape, flow contour and flow direction in a high aspect ratio flow channel.

A fluidic device includes a channel which permits the flow of fluid therethough. High aspect ratio fluid devices, in which the channel height is substantially less than its width, find application in a variety of fields, including sensing. For example, DNA analysis chips include an array of sensor cells in contact with a fluid in a high aspect ratio channel having a small inlet port. One problem with such devices is that, proximate the small inlet, the reagent added to the device does not flow evenly over the array, with the result that some of the cells see more of the reagent than others. The flow contour that arises has a nearly circular shape, and flow at the edges of the channel is limited. The portions of the chip near the sides receive very little treatment of the reagents due to the low-flow condition. The distributed sensing elements receive different flow rates, yielding uneven sensor response.

To address this problem, the DNA analysis chips are manually placed on a shaker prior to analysis. This adds an additional step to the procedure and makes automation difficult.

Many applications are targeted toward mixing of fluids. One uses obstructions to force fluid flowing in a channel to break up and recombine the flow, yielding a mixed flow. See A. A. S. Bhagat, E. T. K. Peterson, and I. Papautsky, “A passive planar micromixer with obstructions for mixing at low Reynolds numbers,” Journal of Micromechanics and Microengineering, vol. 17, pp. 1017-1024, 2007. Another uses bifurcations where the Coanda effect splits and recombines the flow. See C. C. Hong, J. W. Choi, and C. H. Ahn, “A novel in-plane passive microfluidic mixer with modified Tesla structures,” Lab on a Chip, vol. 4, pp. 109-113, 2004. Grooves in top and bottom surfaces of a device have also been used to redirect the flow. D. R. Mott, P. B. Howell, J. P. Golden, C. R. Kaplan, F. S. Ligler, and E. S. Oran, “Toolbox for the design of optimized microfluidic components,” Lab on a Chip, vol. 6, pp. 540-549, 2006; T. M. Floyd-Smith, J. P. Golden, P. B. Howell, and F. S. Ligler, “Characterization of passive microfluidic mixers fabricated using soft lithography,” Microfluidics and Nanofluidics, vol. 2, pp. 180-183, 2006. P. B. Howell, D. R. Mott, S. Fertig, C. R. Kaplan, J. P. Golden, E. S. Oran, and F. S. Ligler, “A microfluidic mixer with grooves placed on the top and bottom of the channel,” Lab on a Chip, vol. 5, pp. 524-530, 2005; F. G. Bessoth, A. J. deMello, and A. Manz, “Microstructure for efficient continuous flow mixing,” Analytical Communications, vol. 36, pp. 213-215, 1999; A. D. Stroock, S. K. W. Dertinger, A. Ajdari, I. Mezic, H. A. Stone, and G. M. Whitesides, “Chaotic mixer for microchannels,” Science, vol. 295, pp. 647-651, 2002. Grooves formed in the top or bottom surfaces of a channel influence fluid flow characteristics, which can lead to improvements in mixing. See, for example, US 2008/0221844.

Fluid entering or flowing in a fluidics channel can have varying velocities for a variety of reasons. Also, if plug flow is desirable, channel geometries can prevent plug flow, or a flat flow contour, from occurring.

### BRIEF DESCRIPTION

In accordance with one aspect of the exemplary embodiment, a micro-fluidic device includes a micro-channel with an inlet port at a first end and an outlet port at a second end. A first fluid is in the micro-channel. A focusing structure extends into the micro-channel, e.g., from a roof of the micro-channel, whereby when a pulse of a second fluid is introduced to the channel, the pulse advances adjacent to the sides of the micro-channel at a faster rate than would occur without the focusing structure.

In accordance with another aspect of the exemplary embodiment, a method of sensing includes providing a micro-channel with an inlet port at a first end and an outlet port at a second end, a sensor array defining, at least in part, a floor or roof of the micro-channel, and a first fluid disposed in the micro-channel. A pulse of a second fluid is introduced to the micro-channel through the inlet port. Flow of the pulse along a longitudinal axis of the micro-channel is restricted, whereby edges of the sensor array are exposed to the pulse without shaking of the micro-channel.

In accordance with another aspect of the exemplary embodiment, a micro-fluidic sensing device includes a micro-channel with an inlet port at a first end and an outlet port at a second end. The micro-channel is defined between a floor and a roof. The roof of the micro-channel is spaced from the floor. A first fluid, such as a gas or liquid, is disposed in the micro-channel. A sensor array defines, at least in part, at least one of the floor and roof of the micro-channel A focusing structure extends into the micro-channel from the other of the floor and the roof by a maximum distance which is less than a spacing between the roof and the floor, whereby a pulse of a second fluid flows between the focusing structure and the sensor array along a longitudinal axis of the micro-channel and at sides of the focusing structure to more closely approximate plug flow over the sensor array than would occur without the focusing structure.

In accordance with another aspect of the exemplary embodiment, a fluidic device includes a channel with an inlet port at a first end and an outlet port at a second end. The channel has a width and a maximum height, perpendicular to the width, the maximum height being defined between a floor and a roof of the channel. A ratio of the width to the maximum height is at least 10:1. A focusing structure extends from the roof or floor into the channel by a maximum distance which is less than the maximum height, the focusing structure having a height which is greater adjacent a longitudinal axis of the channel than adjacent sides of the channel for focusing a pulse of a fluid between the inlet and outlet ports whereby fluid flow adjacent to the sides of the channel is increased.

### BRIEF DESCRIPTION OF THE DRAWINGS

FIG. 1 is a schematic view of a conventional micro-channel showing fluid flow contours;

FIG. 2 is a top plan view of a micro-channel in accordance with one aspect of the exemplary embodiment;

FIG. 3 is a perspective view of a micro-fluidic device incorporating the micro-channel of FIG. 2;

FIG. 4 is a cross-sectional view of a micro-fluidic device in accordance with another aspect of the exemplary embodiment;

FIG. 5 is a side-sectional view of the micro-fluidic device of FIG. 4;

FIG. 6 is a top view of a micro-fluidic device in accordance with another aspect of the exemplary embodiment;

FIGS. 7-10 show top plan views of exemplary fluidic devices illustrating different shapes for a focusing structure or structures in the case of FIG. 9;

FIGS. 11a-f show flow patterns of a plug of dye in simulated micro-fluidic devices in accordance with aspects of the exemplary embodiments.

FIGS. 12a and 12b show flow patterns simulated using the incompressible Navier-Stokes steady state COMSOL® multiphysics solver. FIG. 12a shows the fluid velocity vector field in a channel with no focusing structure and FIG. 12b shows the same for an arbitrarily shaped tapered structure of half the channel height.

### DETAILED DESCRIPTION

Aspects of the exemplary embodiment relate to a fluidic device and to a method of use. The fluidic device is described herein in terms of a micro-fluidic device with a micro-channel, although it is to be appreciated that larger devices are also contemplated.

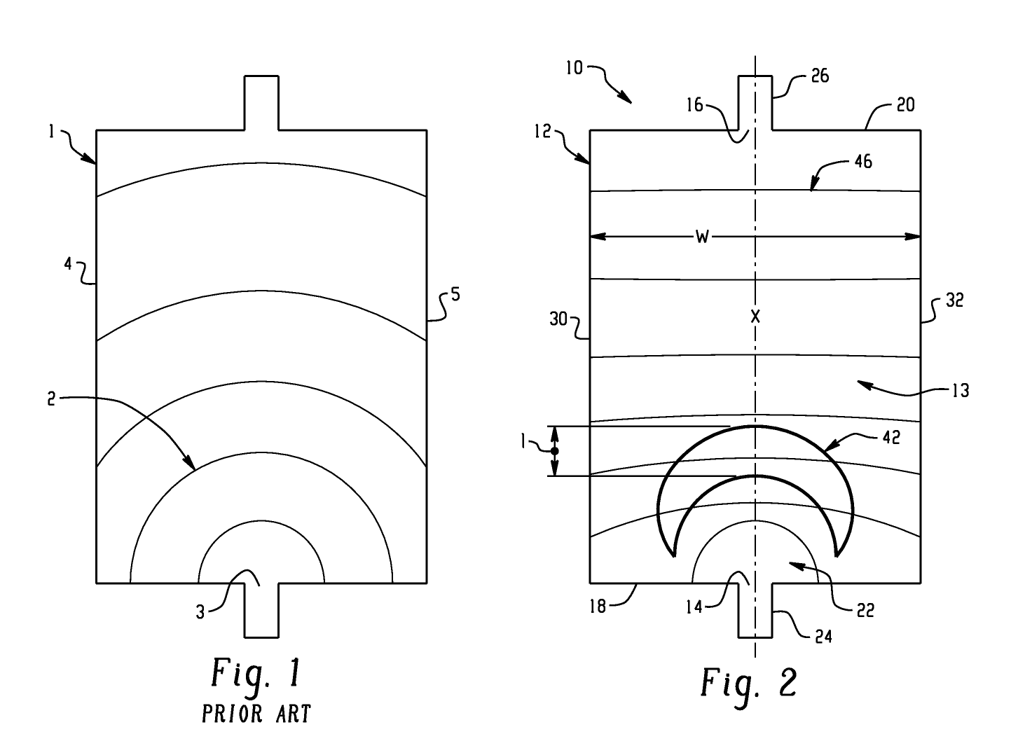

With reference to FIG. 1, an exemplary micro-channel 1 of conventional design is shown. When a pulse 2 of fluid is added to the fluid in the channel via inlet port 3, the sides 4, 5 of the micro-channel see the fluid later than the channel center, as is evident from the contours of the pulse. The quantity of fluid flowing adjacent to the sides is also lower than that at the channel center.

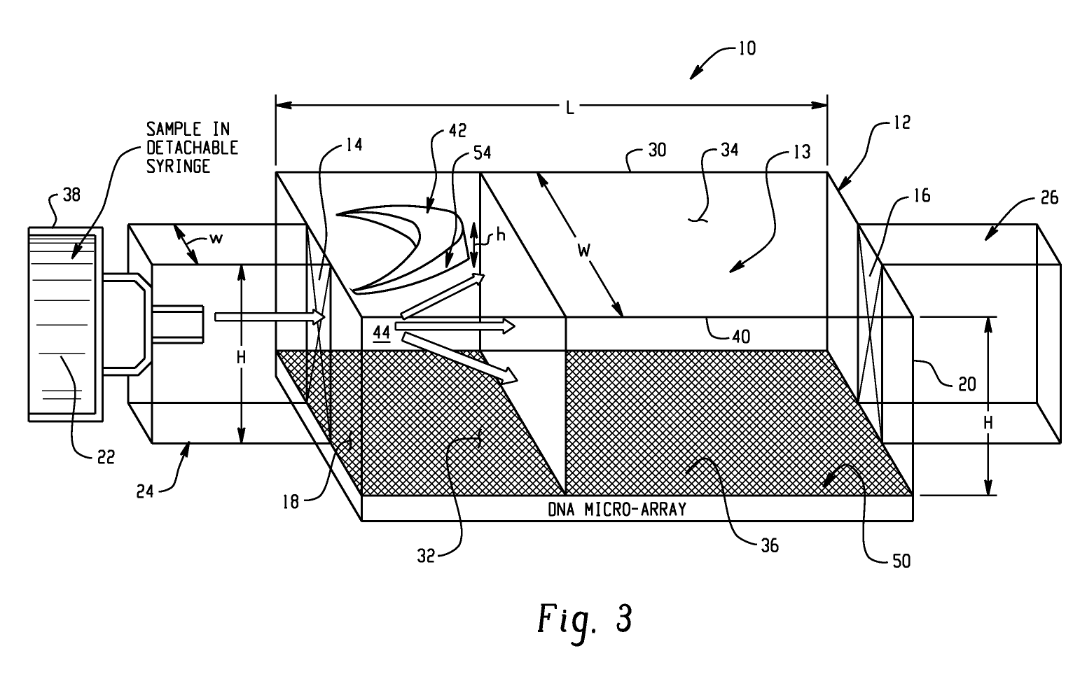

FIGS. 2-3 illustrate a micro-fluidic device 10 in accordance with one aspect of the exemplary embodiment. The micro-fluidic device 10 includes a micro-channel 12. As used herein, a micro-channel is a fluid channel having an inlet port and an outlet at opposite ends and having a maximum height H which is about 2 mm, or less and in one embodiment, is up to 300 μm, and can be at least 0.1 μm. The micro-channel 12 defines an interior chamber 13 which can have an internal volume (height H×width W×length L) of up to about 100 μl, e.g., up to 100 μl, and in one embodiment, up to about 10 μl. In one specific embodiment, the internal volume is about 2 μl or less. The internal volume may be at least 0.1 μl, e.g., at least 1 μl. While the exemplary micro-channel is rectangular in shape, it is contemplated that the corners of the channel may be rounded or otherwise shaped. The exemplary micro-channel 12 is a high aspect ratio channel, i.e., its maximum height H is substantially less than its maximum width W. For example 100H≧W≧10 H, i.e., the ratio of width to the maximum height of the channel can be at least 10:1, e.g., at least 20:1 or greater. In other embodiments, the channel 12 does not have a high aspect ratio, i.e., the aspect ratio could be 2:1, or less, such as 1:1.

The micro-channel 12 includes a fluid inlet port 14 and a fluid outlet port 16 defined in end walls 18, 20 of the micro-channel, respectively. Inlet 14 and outlet 16 may be axially aligned, as shown. Fluid 22, such as a liquid (or gaseous) biological sample or other liquid sample to be tested, enters the inlet port 14 via an inlet tube 24 and exits the outlet 16 of the micro-channel through an exit tube 26. Inlet and outlet 14, 16 can have a width w which is substantially less than the width W of the micro-channel, e.g., W≧10 w. However, in other embodiments, the inlet 14 can have a width which is up to the width of the channel, i.e., w≦W. The inlet 14 and outlet 16 can have a height which is ≦H. The fluid is constrained to travel along the micro-channel by generally parallel opposed side walls 30, 32, a roof 34, and an opposed floor 36, positioned below the roof 34. In the exemplary embodiment, the walls 30, 32, 34, 36 and those in which the inlet and outlet are formed, are all formed from a rigid material, such as plastic, glass, metal, or the like.

As shown in FIG. 3, an aliquot of the liquid sample to be tested can be introduced by a detachable syringe 38, or other sample dispensing device, connected to the inlet tube 24. A sample pulse then travels through the micro-channel. If there is stationary liquid already in the micro-channel, the pulse and the liquid travel through the micro-channel.

The roof 34 has a planar lower surface 40 with the exception of a focusing structure 42, which depends from the roof 34 into the micro-channel by a maximum distance h. h and H are measured in a direction perpendicular to the plane of the roof, i.e., perpendicular to the longitudinal axis x of the channel. h is less than H to provide a gap 44 through which the fluid can flow between the focusing structure and the floor 36 of the micro-channel channel. h can be, for example, at least 0.25H, and can be up to 0.9H, such as up to 0.75H. In one specific embodiment, h is up to about 0.5H. For example, in a micro-channel of about 2 mm in height H, the focusing structure can have a maximum height h which ranges from 0.5-1.5 mm, and in one embodiment, h is less than 1.25 mm. The minimum height of the gap 44 is thus H-h, which in the exemplary embodiment, is at least 0.25H. In some embodiments, the height of the focusing structure 42 varies in height in at least one direction between a minimum height (e.g., about 0 mm) and the maximum height h. In other embodiments, the height of the focusing structure is substantially uniform, e.g., has a height h over at least ⅔ of its area.

The exemplary focusing structure 42 is axially aligned with the length axis x of the micro-channel and is a rigid, stationary structure which may be entirely solid or at least have an exterior surface which is resistant to flexing in response to liquid flow thereover. The focusing structure may be contoured to increase the plug flow character of a pulse of fluid as it passes through the micro-channel, as illustrated by the flow contours in FIG. 2 and the head 46 of the plug. Thus, the height of the focusing structure is not uniform, but varies from zero or close to zero to the maximum h. The exemplary focusing structure has an area in the plane of the roof 34, which is only a small portion of the area (L×W) of the roof of the micro-channel. In particular, the area of the focusing structure which exceeds ⅛^{th} of the height H of the channel is less than ¼ of the area (L×W) of the roof 34, and in one embodiment, less than ⅛^{th}, or less than 1/16^{th} of the area of the roof. For example, in the rectangular embodiment of FIG. 2, the roof area=L×W, and thus the area of the focusing structure is less than ¼L×W. The exemplary focusing structure 42 has a maximum length l parallel to the length axis x of the channel. In one embodiment, the maximum length l≦L. In some embodiments l≦½L.

As will be appreciated, the area of the focusing structure is not limited to such a size and in one embodiment, could occupy the entire roof. In other embodiments, the focusing structure 42 may extend upward from the floor 36, i.e., from a lower surface of the channel, and have similar dimensions.

In the embodiment shown in FIG. 3, the floor 36 of the micro-channel is defined by a sensing element, such as a sensor array 50. An exemplary sensor array is a DNA detection array or “chip” as may be found in a Genechip™, as produced by Affymetrix, or other sensor array. Sensor arrays are disclosed, for example, in U.S. Pub. No. 2007/0092901, the disclosure of which is incorporated herein by reference in its entirety. High density nucleic acid arrays can have, for example, hundreds or thousands of sensor cells (often referred to as spots) for detection of different pathogens. Interactions between the nucleic acid chain or “probe” in each sensor cell and the target pathogen can be detected and quantified by detection of target labels, such as fluorophore, silver, or chemiluminescence labeled targets, to determine relative abundances of particular nucleic acid sequences in the target. The cells can alternatively include antibody receptors. By changing the shape of the fluid flow contour such that all portions of the chip 50 receive the same treatment with a sample liquid or other introduced fluid pulse, the requirement for shaking the device can be eliminated, making automation of the assays in such a chip feasible. In other embodiments, the sensing element may be only a single sensor, rather than an array.

In particular, by changing the height of the roof of the channel in one or more strategic locations with one or more focusing structures 42, the profile of the flow contour can be adjusted as needed. The exemplary focusing structure 42 shown in FIG. 2 is crescent shaped, as viewed from above or below. It is located close to the inlet port 14. With a suitable height and location of the focusing structure(s), the shape of the plug of reagent can be adjusted to be perpendicular to the sides of the channel in a very short distance.

Since flow resistance is inversely proportional to channel dimension, the regions with lowered roof height, as in the region of focusing structure 42 produce a flow path with more resistance. Similar to an electrical current, the fluid follows the path of least resistance. Although in the lowered regions the fluid still flows, the flow rate is reduced in proportion to the channel height. The higher the resistance, the slower the flow. The crescent-shaped focusing structure 42 has the slowest flow straight up the middle of the micro-channel, along the x-axis, and fastest around the sides, thus changing the shape of the plug as it flows over the focusing structure 42.

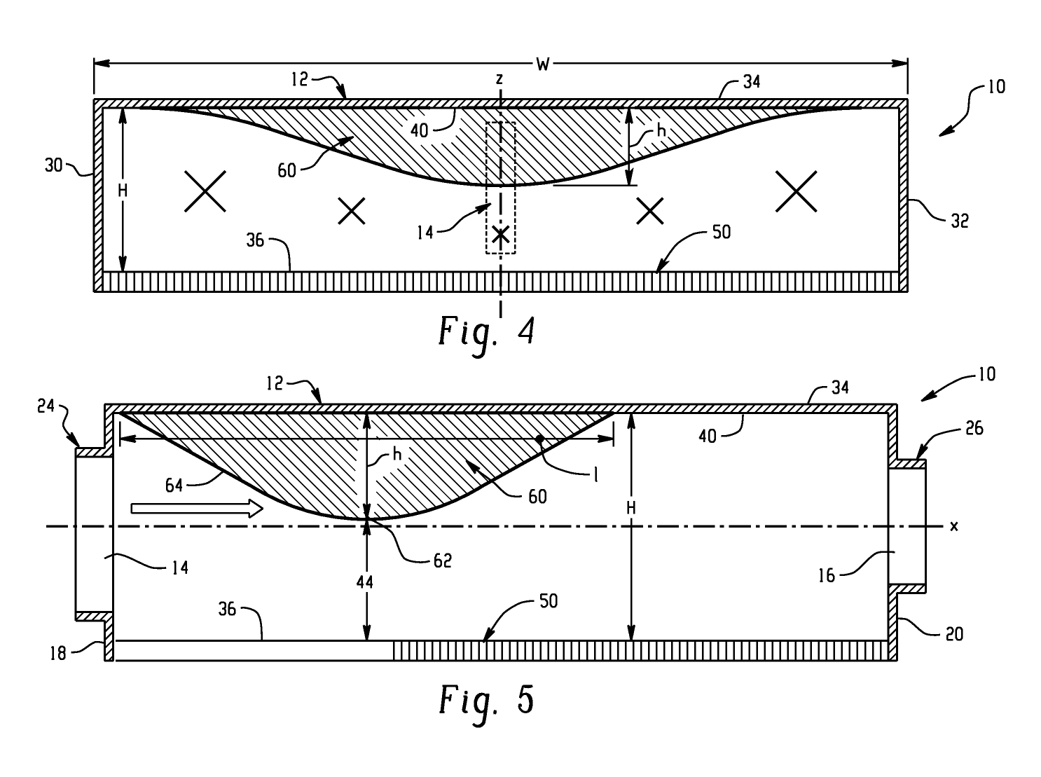

While a contoured crescent shape with its concave surface facing the inlet port and which reaches its maximum height away from the edges of the crescent at about point 54 is one example of a focusing structure, other contoured structures are contemplated. For example the focusing structure can have an approximately Gaussian shape in x and y directions, as illustrated in the micro-fluidic device of FIGS. 4 and 5 which can be otherwise configured as for the device of FIGS. 2 and 3. The hill shaped focusing structure 60 shown in this embodiment also has its maximum height h at a peak 62 positioned along the x axis. The peak 62 is spaced from the inlet port by a contoured surface 64 of the structure of gradually increasing height to avoid breaking up the plug flow. The change in flow rates are suggested by the size of the X's.

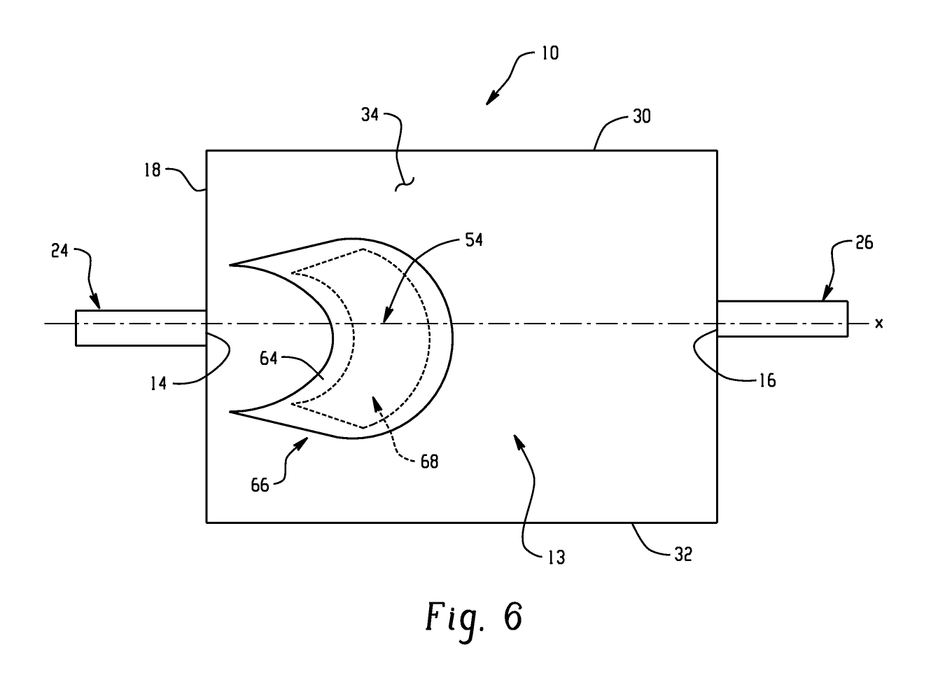

In other embodiments, a focusing structure 66 can have the shape of an arc, as shown in FIG. 6. The focusing structure 66 also has contoured side surfaces 64 so that a maximum height of the focusing structure is on the x axis at a planar surface 68, spaced from the inlet port 14 by a contoured surface 64 of gradually increasing height.

The focusing structures 42, 60, 66 shown herein are symmetrical about the x axis such that the flow rate of the sample pulse along the edges of the array 50 is approximately equal. In other embodiments, the focusing structure may have an asymmetric configuration for increasing the flow in one region while decreasing it in another. In yet other devices, for example, where sensors are on the roof, the focusing structure may alternatively or additionally extend from the floor of the channel.

In the case of a sensing device, the roof 34 of the channel can be optically transparent, or transparent to other electromagnetic radiation used in analyzing the cells of the array 50. For example, the roof of the channel, and optionally also the focusing structure and walls, can be formed of glass, plastic, or the like. The focusing structure 42, 60, 66 may be integrally formed with the roof and made of the same material, e.g., by molding the roof and focusing structure from plastic. Or, lithographic techniques or the like may be used for forming a focusing structure on a planar surface which is to form the roof. In this case, the focusing structure may be formed from a different material than the rest of the roof. Techniques for forming micro-liter volume devices are described, for example, in U.S. Pub No. 2002/0060156 and 2006/0292628, the disclosures of which are incorporated herein by reference in their entireties.

While the exemplary micro-channel is rectangular in top plan view, other structures for the micro-channel are also contemplated. For example, the micro-channel may be U-shaped in top plan view (like a racetrack), rather than rectangular, with the focusing structure 42 located proximate the inlet end of the U. In this embodiment, the focusing structure may be positioned closer to one side of the micro-channel (the inner side) than the other, to compensate for the differences in the flowpath length along the outer and inner sides.

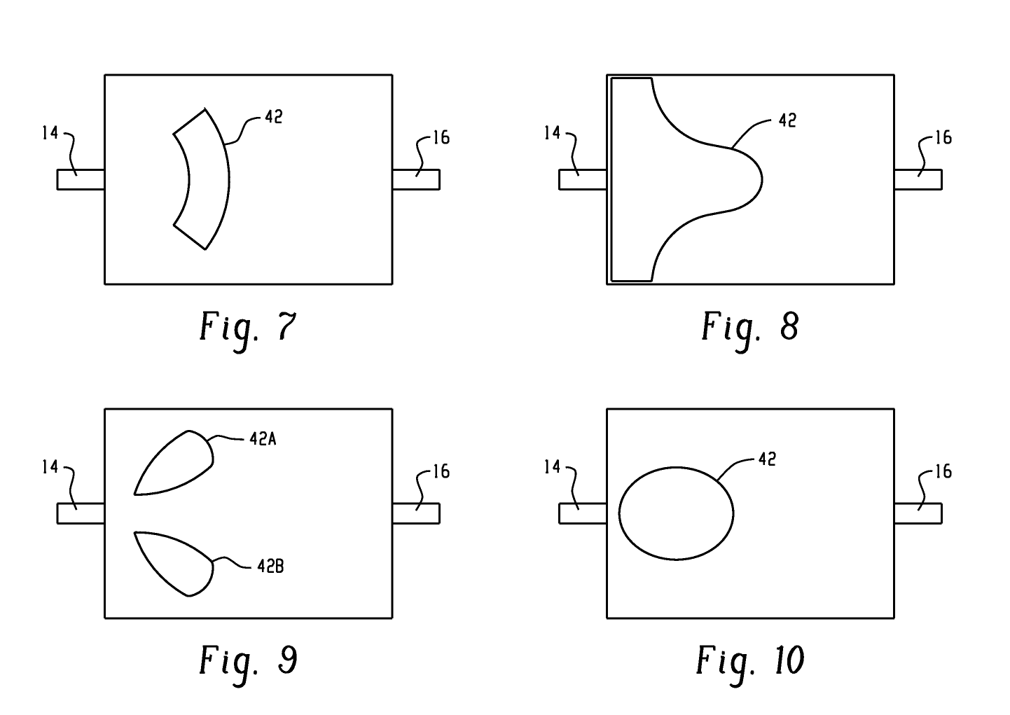

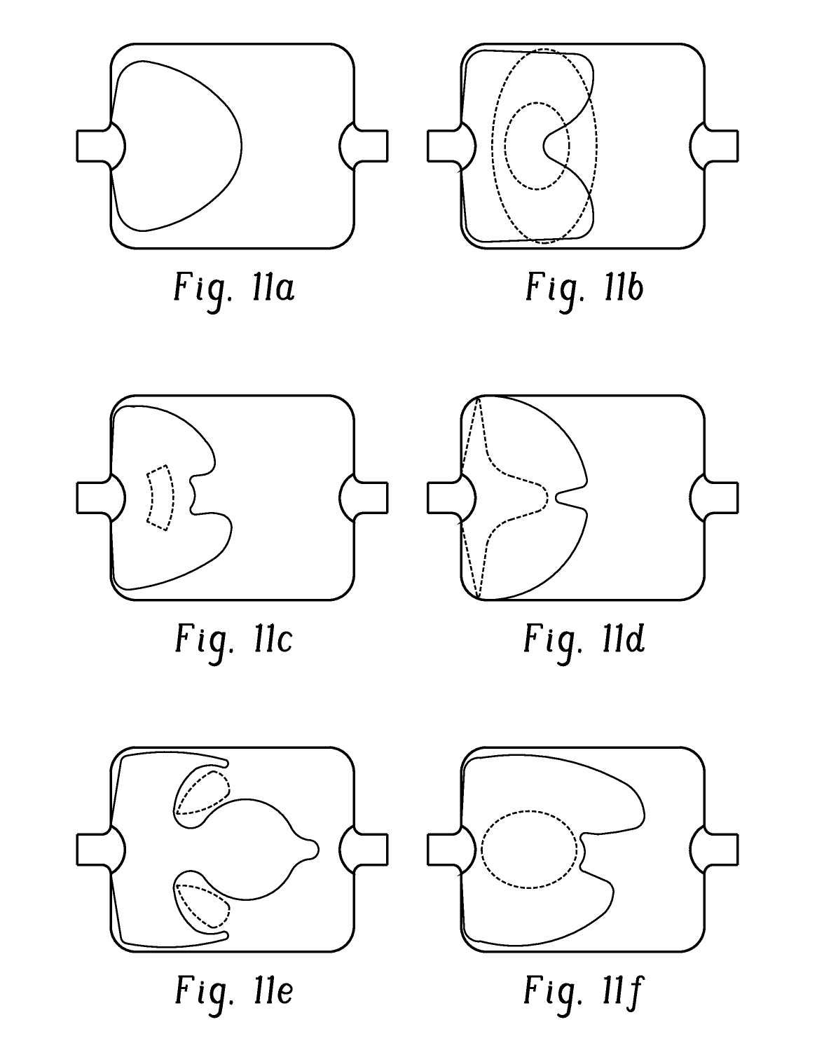

FIGS. 7-10 show top plan views of exemplary fluidic devices illustrating different shapes for a focusing structure 42 or structures in the case of FIG. 9. The structure 42 in FIG. 7 is arcuate and may have a height which is uniform or varying. The structure 42 in FIG. 8 extends from the inlet wall, has a maximum length/along the longitudinal axis of the device and may have a height which is uniform or which varies. The structures 42A and 42B in FIG. 9 are mirror images of each other and equally spaced from the longitudinal axis of the device. The longest dimension of each of the structures 42A and 42B is angled to the longitudinal axis of the device. The two structures may have a height which is uniform or which varies. The structure 42 in FIG. 10 is oval and may have a height which is uniform or varying.

A method of using the microfluidic device 10 shown in any of the disclosed embodiments includes introducing an aliquot of a sample to be tested to the micro-channel 12, allowing the sample to flow over the array 50, and for excess liquid to be discharged through the outlet port. The sample may be left in contact with the array for a prescribed time, followed by washing the array, e.g., by introducing another fluid through the inlet port. Finally, detection includes examining the array for evidence of reaction of target species in the sample with one or more of the probes of the array. The exemplary method excludes a shaking step—the micro-fluidic device including the array can remain fixed in position throughout the procedure. However, in other embodiments, shaking may be performed.

While in the exemplary embodiment, the focusing structures are configured for enhancing plug flow, i.e., achieving a flow which is closer to that of FIG. 2 than the radiating flow shown in FIG. 1, it is also contemplated that other flow characteristics may be achieved which differ from either plug flow or conventional radiating flow patterns. The exemplary focusing structure is configured such that, when a pulse of a second fluid is introduced to the channel, the pulse advances adjacent to the sides of the micro-channel at a faster rate than would occur without the focusing structure (FIG. 1), although it is to be appreciated that other flow patterns which could be created by the focusing structure are also contemplated.

The exemplary micro-channel with a focusing structure has a variety of applications including use in a Genechip™ chamber or other biosensor chamber to produce even flow across width of chamber. However, other devices are also contemplated where a change in flow characteristics is desired.

As will be appreciated, the exemplary micro-fluidic device 10 is not limited to sensor applications. It may also be used to minimize or eliminate effects of Poiseuille flow, to minimize or eliminate the effects of dispersion on plug flow so that plug flow will maintain integrity longer. Other applications include fluid focusing and eliminating the racetrack effect. This latter is due to the longer path around the outside of a curved channel. The flow thus normally deviates from plug flow around the curve. The present focusing structure can be used to provide resistance to flow along the shorter inner edge of the curved channel, evening out the flow across the channel. As another example, where the channel inlet w≧½W, the focusing structure may be used to prevent parabolic flow and maintain plug flow for the length of the channel.

Another application is to adjust roof shape “on-the-fly” to direct fluid flow in real time (e.g., for sorting).

Without intending to limit the scope of the exemplary embodiment, the following examples demonstrate a method for identifying suitable focusing structures for achieving different flow characteristics.

### Example

Microfluidic devices without sensors were prepared to simulate fluid flow in actual micro-fluidic devices. Clear poly(methyl methacrylate) (PMMA) sheet material was used to fabricate a roof and floor of a micro-channel. The two layers were separated by rubber about 1 mm in thickness with a cut out to define the micro-channel (approximately 31×34×1 mm) and inlet and outlet tubes. A red rubber was used for clarity. The micro-channel was filled with a clear liquid.

A 100 μl plug of dyed water was injected into the channel via the inlet port. FIGS. 11a-f show that a variety of flow contours is possible using structures similar to those shown in FIGS. 7-10. The focusing structure in each of embodiments 11b-f is intended to be symmetrical about the longitudinal axis, although due to the method of making the structures, the shape of the structures was not as exact as could be expected by molding the focusing structure from plastic.

FIG. 11a shows the flow pattern around the inlet (LHS) for a conventional micro-channel with a planar roof. The plug should appear circular. However, the nearness of the outlet port likely distorts the shape to be slightly thinner.

FIG. 11b shows a similar plug of dye, except the top plate of the micro-channel has a smooth layer of clay built up in the middle to simulate an elongate focusing structure (the inner dashed ring indicates the deepest part of the focusing structure). The micro-channel height was lowest in the center and highest towards the sides, increasing the path resistance down the middle of the chamber, forcing fluid to flow more slowly down the middle and providing more flow down the sides. Rather than a rounded pulse, the focusing structure creates two lobes and there is flow closer to the edges of the channel. As will be appreciated, if the height of the focusing structure had been somewhat less, a more uniform plug flow could have been generated.

FIGS. 11c-f show results with alternative focusing structure configurations (with their approximate shapes shown in dashed lines) made from several layers of tape (totaling ˜0.5 mm thick) cut out and attached to the top of the channel. FIGS. 11c and 11f have a small ramp of clay on the proximal end of the tape to ensure that the effect on the fluid is from path resistance and not due to the leading edge of the tape diverting the flow. The focusing structure in FIG. 11c was thus similar to that shown in FIG. 6. The structure in FIG. 11d simulates a Gaussian function which extends from the inlet wall in the length L direction by a distance which decreases away from the central axis x. The focusing structure of FIG. 11e has two lobes, effectively creating two focusing structures situated equidistant from the x axis. FIG. 11f has a generally circular focusing structure of substantially uniform height.

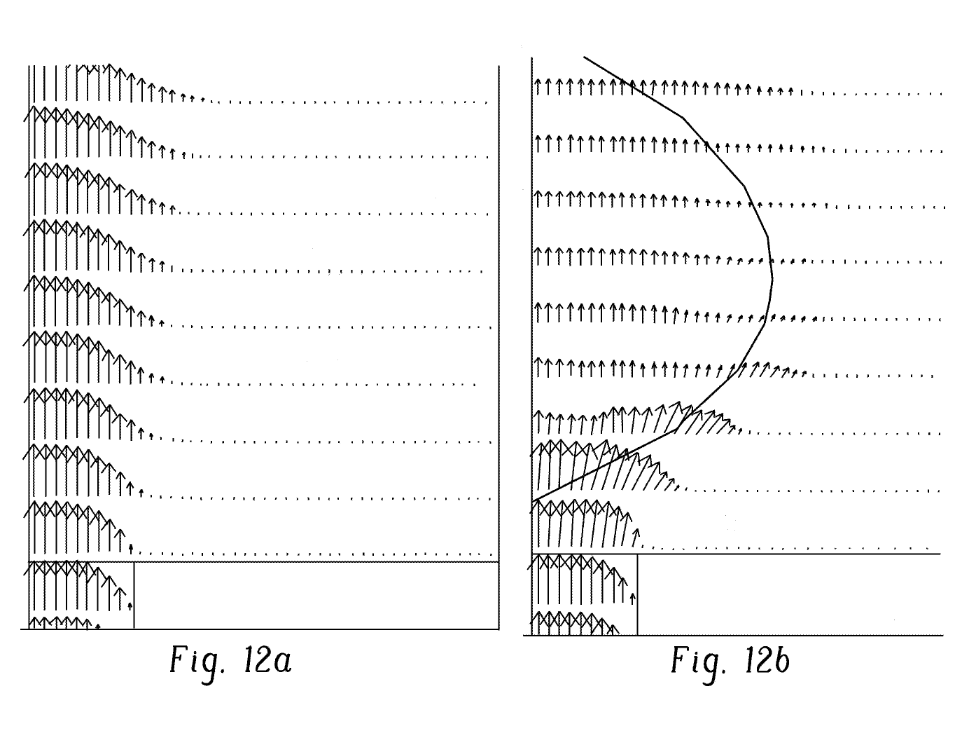

A flow channel with a portion of the roof lowered, as in the examples using shapes cut out from tape, was simulated using the incompressible Navier-Stokes steady state COMSOL® multiphysics solver. FIG. 12a shows the fluid velocity vector field over the channel with no tape. FIG. 12b shows the same for roughly circular shaped tape structure where h is about one half of the channel height H, similar to that shown in FIG. 11f. Note the change in flow velocity and direction due to the various path resistances.

The exemplary embodiment(s) described herein have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A micro-fluidic device comprising:
a micro-channel with an inlet port at a first end and an outlet port at a second end;
a first fluid in the micro-channel;
a focusing structure which extends into the micro-channel, whereby when a pulse of a second fluid is introduced to the channel, the pulse advances adjacent sides of the micro-channel at a faster rate than would occur without the focusing structure.

2. The micro-fluidic device of claim 1, wherein the focusing structure extends into the micro-channel by a maximum distance which is at least one quarter of a height of the channel.

3. The micro-fluidic device of claim 1, wherein the focusing structure extends into the micro-channel by a maximum distance which is less than the height of the channel.

4. The micro-fluidic device of claim 1, wherein the focusing structure is contoured and has a peak height further from the inlet port than an edge of the focusing structure.

5. The micro-fluidic device of claim 1, wherein the focusing structure has a peak height along a longitudinal axis of the micro-channel.

6. The micro-fluidic device of claim 1, wherein the focusing structure is crescent shaped.

7. The micro-fluidic device of claim 1, wherein the focusing structure is symmetrical about the longitudinal axis.

8. The micro-fluidic device of claim 1, wherein the micro-channel has a volume of less than 100 μl.

9. The micro-fluidic device of claim 8, wherein the micro-channel has a volume of less than 10 μl.

10. The micro-fluidic device of claim 1, wherein the micro-channel has a maximum height which is less than 2 mm.

11. The micro-fluidic device of claim 1, wherein the micro-channel has a width, perpendicular to a longitudinal axis of the micro-channel, which is at least ten times a maximum height of the micro-channel.

12. The micro-fluidic device of claim 1, wherein the focusing structure extends from a roof of the micro-channel.

13. The micro-fluidic device of claim 1, wherein at least one of the floor and the roof of the micro-channel is defined, at least in part, by a sensing element.

14. The micro-fluidic device of claim 13, wherein the sensing element comprises a sensor array.

15. The micro-fluidic device of claim 14, wherein the sensor array comprises a DNA analysis chip.

16. The micro-fluidic device of claim 14, wherein the roof of the micro-channel, above the sensor array, is formed from a transparent material.

17. The micro-fluidic device of claim 1, further comprising an inlet tube in fluid communication with the inlet port, the inlet tube being configured for receiving the pulse of second fluid from a sample dispensing device.

18. The micro-fluidic device of claim 1, wherein the first fluid is a liquid.

19. The micro-fluidic device of claim 17, wherein the second fluid is a liquid.

20. A method of sensing comprising:
providing a micro-channel with an inlet port at a first end and an outlet port at a second end, a sensor array defining, at least in part, a floor or roof of the micro-channel, and a first fluid disposed in the micro-channel;
introducing a pulse of a second fluid to the micro-channel through the inlet port; and
restricting flow of the pulse along a longitudinal axis of the micro-channel, whereby edges of the sensor array are exposed to the pulse without a need for shaking of the micro-channel.

21. The method of claim 20, further comprising analyzing the sensor array for reaction of target species in the second fluid with probes or antibody receptors defining cells of the array.

22. The method of claim 20, wherein the restricting flow of the pulse along a longitudinal axis of the micro-channel comprises providing a focusing structure which depends from a roof of the micro-channel to reduce a height of the micro-channel over only a portion of the roof.

23. A micro-fluidic sensing device comprising:
a micro-channel with an inlet port at a first end and an outlet port at a second end;
a first fluid disposed in the micro-channel;
the micro-channel including a floor and a roof, the roof being spaced from the floor; and
a sensor array defining, at least in part, at least one of the floor and roof of the micro-channel;
a focusing structure which extends from the other of the floor and roof into the micro-channel by a maximum distance which is less than a spacing between the roof and the floor, whereby a pulse of a second fluid flows between the focusing structure and the sensor array along a longitudinal axis of the micro-channel and at sides of the focusing structure to more closely approximate plug flow over the sensor array than would occur without the focusing structure.

24. A fluidic device comprising:
a channel with an inlet port at a first end and an outlet port at a second end, the channel having a width and a maximum height perpendicular to the width, the maximum height being defined between a floor and a roof of the channel, a ratio of the width to the maximum height being at least 10:1; and
a focusing structure which extends from at least one of the roof and the floor into the channel by a maximum distance which is less than the maximum height, the focusing structure having a height which is greater adjacent a longitudinal axis of the channel than adjacent sides of the channel for focusing a pulse of a fluid between the inlet and outlet ports whereby fluid flow adjacent to the sides of the channel is increased.
